(19) United States
(12) Patent Application Publication
(10) Pub. No.: US 2013/0173521 A1
(43) Pub. Date: Jul. 4, 2013

(54) KNOWLEDGE BASE FOR SERVICE TICKETING SYSTEM

(71) Applicants: Jeremy Pirlet, North Branch, MN (US); Andrew Johnson, Minneapolis, MN (US); Kim Uyen Pham, Rosemount, MN (US)

(72) Inventors: Jeremy Pirlet, North Branch, MN (US); Andrew Johnson, Minneapolis, MN (US); Kim Uyen Pham, Rosemount, MN (US)

(73) Assignee: TARGET BRANDS, INC., Minneapolis, MN (US)

(21) Appl. No.: 13/341,665

(22) Filed: Dec. 30, 2011

(51) Int. Cl. G06N 5/02

(52) U.S. Cl. 706/47

(57) ABSTRACT

A knowledge base system integrates with one or more ticketing systems. In accordance with some embodiments, the knowledge base system allows support technicians to apply articles to service tickets such that uniform resource locators for the articles are stored with the other data of the service ticket and can be seen when viewing a user interface that displays service ticket data. In accordance with some embodiments, the support technician can store an article in a service ticket without viewing the article if the support technician has previously viewed the current version of the article. If the support technician has not viewed the current version of the article, the knowledge base system requires the support technician to view the article before it can be applied to a service ticket.

### BACKGROUND

Helpdesks and support centers provide product assistance. Typically, a customer contacts the helpdesk or support center by phone or email and describes a problem or question. A support technician working at the helpdesk or support center provides an answer or solution to the customer's problem often by consulting a knowledge base containing information about the product or system.

Some helpdesks and support centers utilize tracking systems, also known as ticketing systems, service ticket systems or ticketing applications, to log the problems customers are having and to track the resolution of those problems. In many ticketing systems, a service ticket is generated when the customer contacts the helpdesk and remains open until the problem has been resolved or the question has been answered. The service ticket is a data element that is populated with the identity of the customer, the identity of the product, the nature of the problem, the date and time the ticket was opened, the efforts made to resolve the problem, the final resolution of the problem, the name(s) of support technician(s) who worked to resolve the problem and the date the service ticket was closed.

The discussion above is merely provided for general background information and is not intended to be used as an aid in determining the scope of the claimed subject matter. The claimed subject matter is not limited to implementations that solve any or all disadvantages noted in the background.

### SUMMARY

If a current version of a knowledge base item has been previously displayed to a user, at least one identifier for the knowledge base item is displayed together with an apply-item graphical element such that when the apply-item graphical element is selected, information about the knowledge base item is stored without redisplaying the knowledge base item, wherein the stored information allows a ticketing application to apply the knowledge base item to a service ticket. If the current version of the knowledge base item has not been displayed to the user, at least one identifier for the knowledge base item is displayed together with a new-item graphical element, such that the ticketing application is prevented from applying the knowledge base item to a service ticket on behalf of the user until the current version of the knowledge base item has been displayed to the user.

A computer-implemented method includes receiving a first search query and a knowledge base parameter from a browser client, the knowledge base parameter being associated with a first ticketing application and the first search query being based on a description of a problem entered in the first ticketing application. A search index is searched to retrieve information about knowledge base articles that match the search query and the knowledge base parameter. Information for the knowledge base articles that match the search query and the knowledge base parameter is displayed and the first knowledge base parameter is displayed. A second knowledge base parameter is selected and the second knowledge base parameter is displayed in place of the first knowledge base parameter. An indication to perform a search is received based on a second search query. The search index is searched to retrieve information about knowledge base articles that match the second search query and the second knowledge base parameter. The information for the knowledge base articles that match the second search query and the second knowledge base parameter is displayed.

A system includes a web application component configured to provide a web page comprising an identifier for a knowledge base article and an apply-article icon associated with the knowledge base article. The web application component is configured to receive an indication that the apply-article icon was selected and in response, store a session identifier and knowledge base article information in a session table. An embedding web service configured to receive the session identifier in a request for the knowledge base article information from a ticketing application, to retrieve the knowledge base article information from the session table using the session identifier, and to forward the knowledge base article information to the ticketing application.

A graphical user interface is generated on a display by retrieving information about articles in a knowledge base stored in memory. The information includes a date that a current version of the article was created. A recently updated articles table is displayed in the graphical user interface that shows information about at least two of the articles in the knowledge base with the information ordered based on the dates that the current version of each article was created. Articles in the knowledge base that have been applied to a service ticket are identified as recently used articles and for each recently used article, the last date that the recently used article was applied to a service ticket is determined. A recently used articles table is displayed in the graphical user interface that shows information about recently used articles ordered based on the last dates the articles were applied to a service ticket.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a helpdesk system in accordance with one embodiment.

FIG. 2 is a flow diagram of a method of identifying, selecting and applying knowledge base articles in accordance with one embodiment.

FIG. 3 is an example user interface of a ticketing system.

FIG. 4 is an example user interface for a search results page.

FIG. 5 is an example of a view article user interface.

FIG. 6 is an example of a view article user interface after an article has been applied to a service ticket.

FIG. 7 is an example a search results page user interface after applying an article to a service ticket.

FIG. 8 is a flow diagram of a method of completing the application of a knowledge base article to a service ticket.

FIG. 9 is an example user interface showing a knowledge page of a ticketing system.

FIG. 10 is an example user interface showing a knowledge page of a ticketing system after a knowledge base article has been applied to the service ticket.

FIG. 11 is a flow diagram of a method of applying a search to a new knowledge database.

FIG. 12 provides an example of a user interface for selecting a new knowledge base database.

FIG. 13 provides an example user interface of a search page after a new knowledge base database has been selected.

FIG. 14 provides a flow diagram for displaying a knowledge base homepage user interface.

FIG. 15 provides an example user interface of a knowledge base homepage.

FIG. 16 provides a block diagram of hardware components used to practice the various methods of the embodiments.

### DETAILED DESCRIPTION

The innovations described herein are directed to a knowledge base system that integrates with one or more ticketing systems. In accordance with some embodiments, the knowledge base system allows support technicians to apply articles to service tickets such that uniform resource locators for the articles are stored with the other data of the service ticket and can be seen when viewing a user interface that displays service ticket data. In accordance with some embodiments, the support technician can store an article in a service ticket without viewing the article if the support technician has previously viewed the current version of the article. If the support technician has not viewed the current version of the article, the knowledge base system requires the support technician to view the article before it can be applied to a service ticket.

In accordance with some embodiments, the knowledge base system allows a support technician to view and search articles from different knowledge base databases that are each associated with different ticketing systems. The knowledge base system also integrates with multiple ticketing systems and allows support technicians using different ticketing systems to apply knowledge base articles from the same knowledge base databases.

The knowledge base system also provides a homepage which includes four separate tables: one table for viewing a list of recently updated articles, one table for viewing a list of recently used articles, one table for viewing a list of articles that have been revised by the support technician, and one table for viewing articles that are waiting to be approved by the support technician.

In the discussion below, the support technician who is working with the knowledge base system and the ticketing system is referred to as the user of the system. The person whose problem is being addressed is referred to as the client or customer. Note that the use of the terms client and customer is not intended to indicate a commercial relationship between the support technician and the person who contacts the support technician. In fact, the person calling the helpdesk may be in the same organization as the support technician.

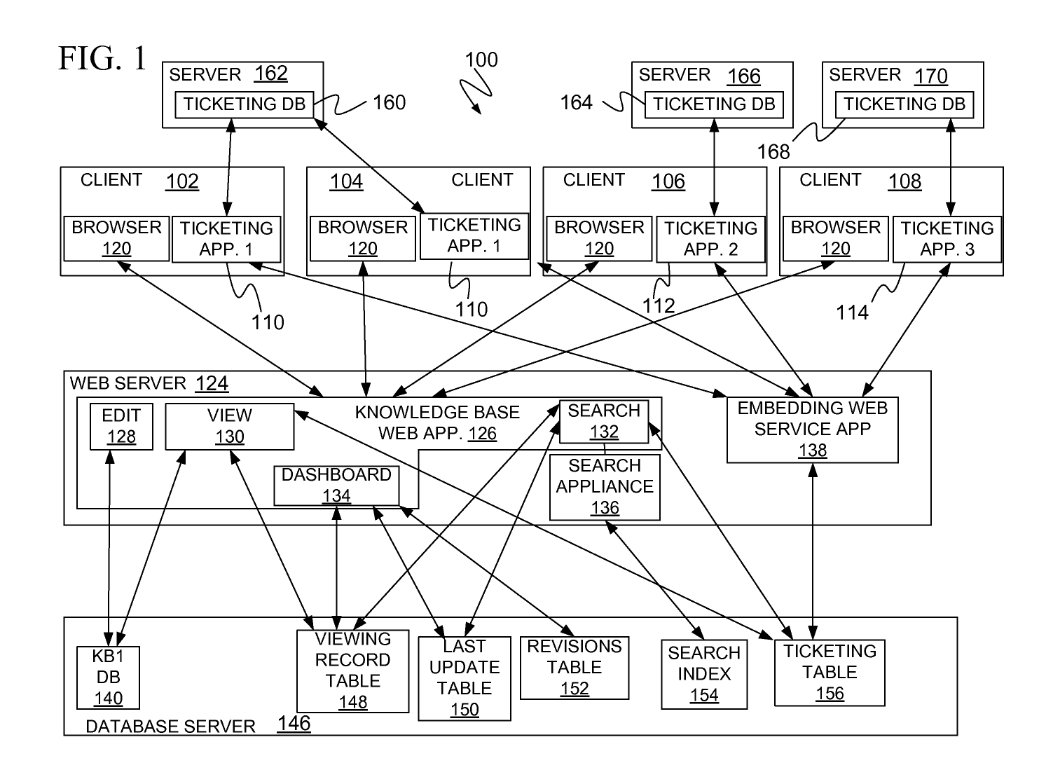

FIG. 1 provides a block diagram of a helpdesk system 100 that includes client devices 102, 104, 106, and 108; servers 162, 166 and 170; web server(s) 124; and database server(s) 146. Client devices 102, 104, 106, and 108 are in network communication with web server(s) 124, which is in network communication with database server(s) 146. Client devices 102 and 104 are in network communication with server 162, client device 106 is in network communication with server 166, and client 108 is in network communication with server 170.

Client devices 102, 104, 106 and 108 are each capable of executing separate instances of a web browser 120, which may be any available browser such as Internet Explorer®, Firefox®, Chrome and Safari®.

Clients 102 and 104 are also capable of executing separate instances of a ticketing application (also referred to as a ticketing system) 110. Client 106 is capable of executing ticketing application/ticketing system 112 and client 108 is capable of executing ticketing application/ticketing system 114. Ticketing applications 110, 112, and 114 may each be from different vendors and provide different user interfaces. In general, ticketing applications from different vendors will be used to support different products. In accordance with some embodiments, a same ticketing application can be used to support more than one product.

Ticketing application 110 on clients 102 and 104 store and retrieve data from ticketing database 160, which contains the data of each service ticket that has been created by the instances of ticketing application 110. Ticketing application 112 on client 106 stores and retrieves data from ticketing database 160, which contains the data of each service ticket that has been created by the instances of ticketing application 112. Ticketing application 114 on client 108 stores and retrieves data from ticketing database 168, which contains the data of each service ticket that has been created by the instances of ticket application 114.

The instances of browsers 120 on clients 102, 104, 106 and 108 call pages on a web server 124 that together form a knowledge base web application 126. The knowledge base web application 126 comprises an edit component 128, a view component 130, a search component 132 and a dashboard component 134. Web server 124 also includes a search appliance 136 that works with and communicates with search component 132 and an embedding web service application 138, which is called by ticketing applications 110, 112 and 114 as discussed further below.

Edit component 128 and view component 130 access knowledge base articles in knowledge base database 140 on database server 146. A knowledge base article may take the form of text, audio, video or audio and video. Knowledge base articles may alternatively be referred to as knowledge base items. View component 130, search component 132 and dashboard component 134 each access viewing record table 148 of database server 146, which holds data describing the last time the user viewed a knowledge based article and the number of times the user has embedded the article in a service ticket.

Dashboard component 134 and search component 132 also access a last update table 150, which contains data describing the last date that a knowledge base article was updated and the name of the user who revised the article. Dashboard component 134 also accesses a revision table 152 on database server 146. Revision table 152 provides data on each revision made to an article including who made the revision, the date of the revision, who approved the revision, the date of the approval, the publication date of the revision, and the current status of the revision.

Search appliance 136 accesses search indices 154 on database server 146. Search indices 154 provide keyword indices for knowledge base database 140. Search appliance 136 performs key word searching in search indices 154 to identify articles in the knowledge base database 140 that contain words in search query provided by search component 132.

View component 130, search component 132 and embedding web service application 138 each access a ticketing application table 156 on database server 146. Ticketing application table 156 includes entries that associate a session ID with information about an article that is to be applied to a service ticket.

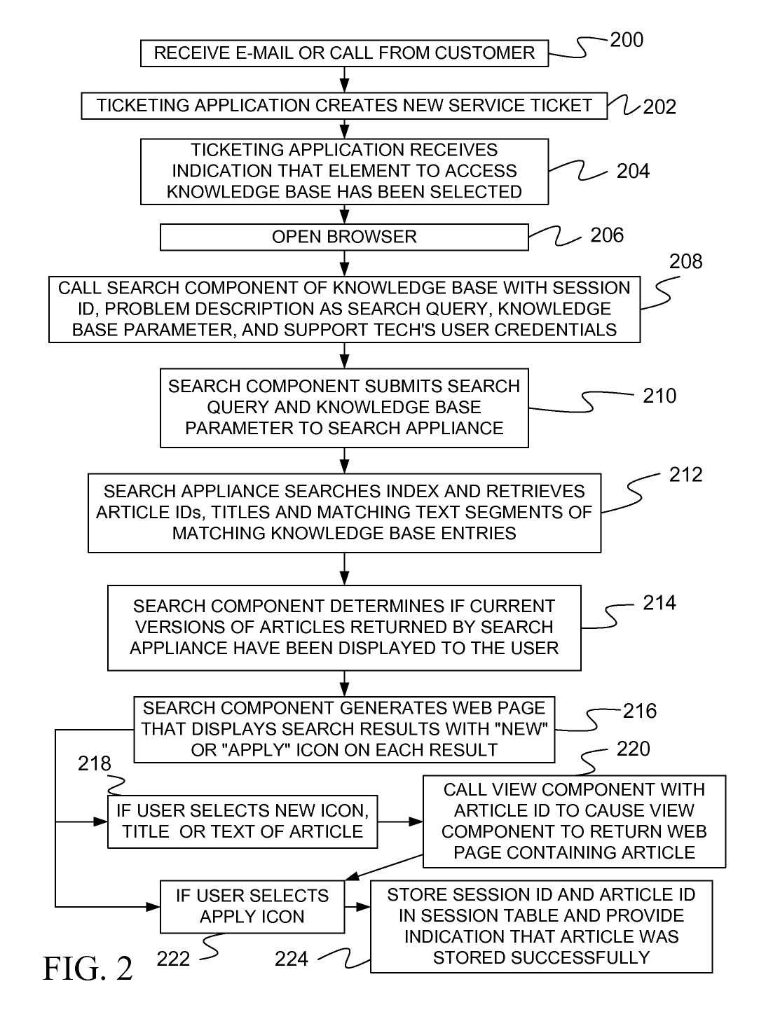

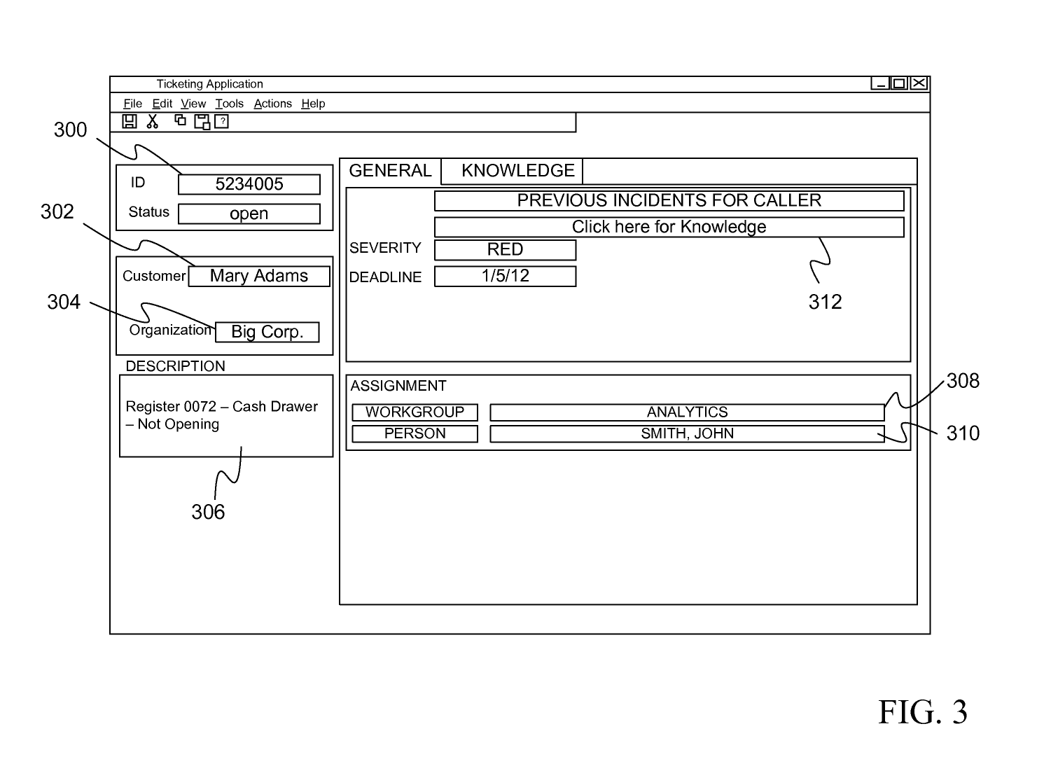

In step 200 in FIG. 2, a call is received from a customer or client. A support technician uses one of the ticketing applications 110, 112 and 114 to create a new service ticket for the customer's problem at step 202. FIG. 3 provides an example of a user interface generated by a ticketing application for creating a new service ticket. As shown in the user interface of FIG. 3, an identification number field 300 provides the identification number of the service ticket and has a value of “5234005”. A customer field 302 has been filled in with a value of “Mary Adams” and a customer organization field 304 has been filled in with a value of “Big Corp.” The user interface of FIG. 3 also provides a description field 306, which contains a written description of the problem. A workgroup field 308 indicates a workgroup at the helpdesk that will be responsible for the service ticket as well as a person field 310 that indicates the name of the support technician who will be responsible for the service ticket.

The user interface of FIG. 3 also provides a selectable graphical element in the form of a knowledge link button 312. When the user selects knowledge link button 312, the ticketing application receives an indication of the selection at step 204 and in response opens a browser window 120 at step 206.

At step 208, search component 132 of knowledge base web application 126 is called by the ticketing application through browser 120. In the call, the ticketing application passes: a session identifier; the problem description from field 306 of the user interface of FIG. 3 as a search query; a knowledge base parameter; and the user's credentials. The knowledge base parameter is associated with the ticketing application and identifies which records in the knowledge base database 140 contains articles relevant to the products supported by the ticketing application and thus identifies which records of knowledge base database 140 should be searched by search component 132. In accordance with several embodiments, knowledge base database 140 includes a table with a column for the knowledge base parameter that identifies which ticketing application is associated with each article. The support technician's user credentials consist of at least a user name that uniquely identifies the support technician.

At step 210, search component 132 submits the search query and the knowledge base parameter to search appliance 136. At step 212, search appliance 136 searches search index 154 based on the knowledge base database parameter and x the search query to identify those articles that contain the terms found in the search query and that are associated with the ticketing application. For each article that search appliance 136 determines matches the search query and the ticketing application, search appliance 136 returns an article ID, a title, and matching text segments from the article.

At step 214, search component 132 determines if the current versions of the articles returned by search appliance 136 have been viewed by the user. To determine this, search component 132 accesses viewing record table 148 to determine the last time the article was displayed to the user. Search component 132 then access last updated table 150 to determine the later of the last time the article was changed or the date the article was written.

At step 216, search component 132 returns a web page to browser 120 that displays the search results with either a “new” or an “apply-item” graphical element/icon displayed next to each article's title and text. Specifically, a “new” icon is displayed next to an article's title if the last date on which the article was displayed to the user is earlier than the later of the last date the article was revised or the date the article was written. In other words, the “new” icon is placed next to an article's title if the current version of the article has not been displayed to the user. An “apply-item” or “apply” icon is displayed next to an article's title if the last date on which the article was displayed to the user is later than the later of the last date the article was revised or the date the article was written. In other words, the “apply-item” or “apply” icon is displayed next to an article's title if the current version of the article has been displayed to the user.

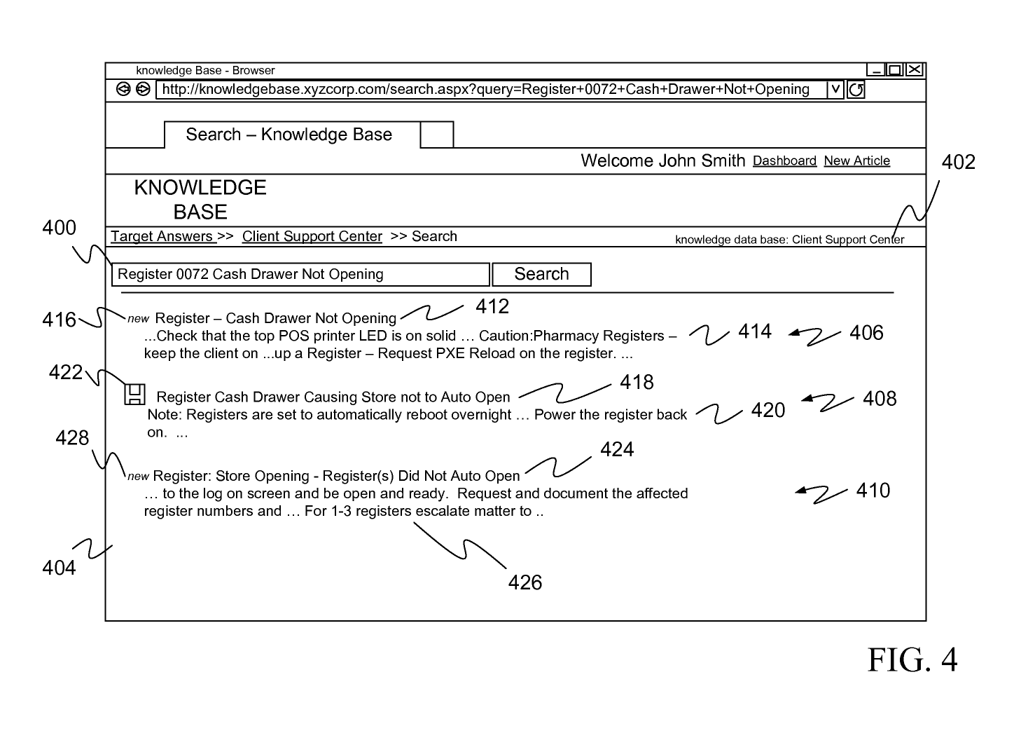

FIG. 4 provides an example of a user interface displaying a search results page returned by search component 132 and displayed by browser 120. In the user interface of FIG. 4, the search text submitted to search appliance 136 is shown in search field 400 and the current knowledge base parameter value is shown in knowledge base database field 402. In a search results field 404, three search results 406, 408 and 410 are provided. Search result 406 includes an article title 412, matching text 414 and a “new” icon 416. Search result 408 includes article title 418, matching text 420 and “apply-item” icon 422, which takes the form of a storage disc. Search result 410 includes article title 424, matching text 426 and “new” icon 428.

If the user selects a “new” icon, an article title or matching text of an article in search results area 404 at step 218, view component 130 is called by browser 120 at step 220. In particular, browser 120 generates a request to view the article that is directed to view component 130 and that includes the identifier for the article. The article identifier may be embedded in the code of the webpage returned by search component 132. In response to the request, view component 130 uses the article identifier to retrieve the article from the knowledge base database 140 and returns a web page to browser 120 that displays the article if the article is textual or includes an appropriate player if the article is an audio clip or a video clip.

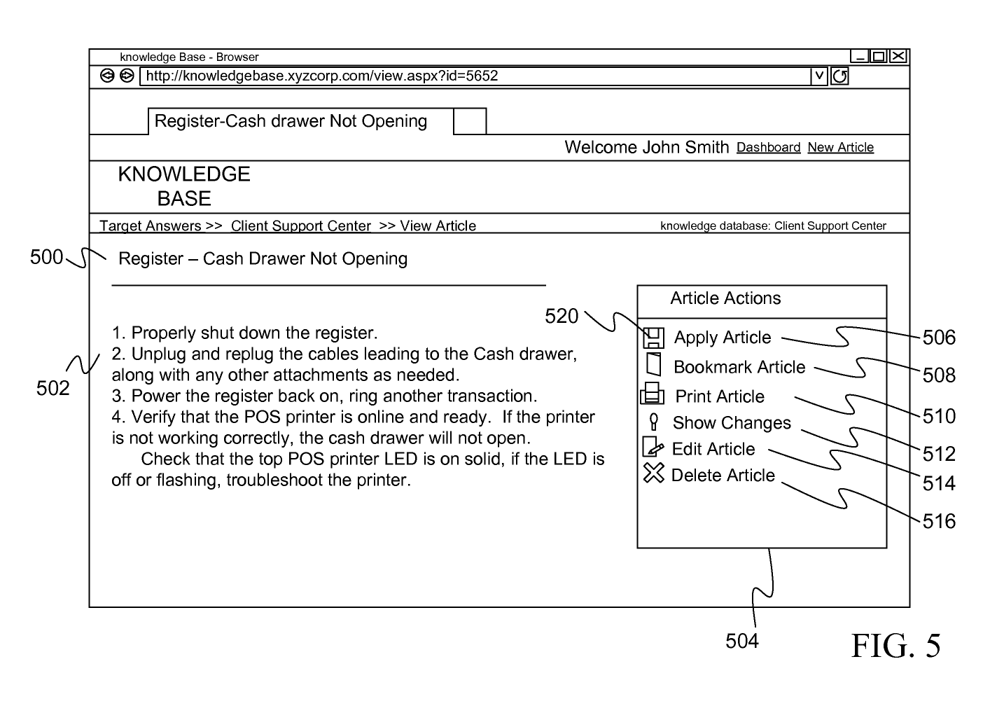

FIG. 5 provides an example of a user interface generated through browser 120 by view component 130 in step 220 of FIG. 2. FIG. 5 includes title area 500 in which the title of the article is displayed and text area 502 containing the text of the article. The user interface of FIG. 5 also includes an Article Actions menu 504 that includes a list of actions that may be performed relative to the article. Actions in article menu 504 include Apply Article instruction 506, Bookmark Article instruction 508, Print Article instruction 510, Show Changes instruction 512, Edit Article instruction 514 and Delete Article instruction 516. Each of the items in menu 504 may be selected to activate the action represented by the item.

Apply Article instruction 506 includes an “apply-item”/“apply-article”/“apply” graphical element/icon 520 that can be selected to store information about the article so that the article may be applied to a service ticket. If the user selects apply icon 520 at step 222, view component 130 stores a session identifier, article title, article uniform resource locator (URL) and article ID in a ticketing application table 156. The session identifier is the same session identifier provided by the ticketing application when first calling knowledge base web application 126. The information stored in ticketing application table 156 will later be retrieved from the table in order to store the information in a service ticket. In addition, at step 224, the current webpage displayed by browser 120 is updated to replace the “apply” icon with a “confirmation” or “success” graphical element/icon and to provide a text message indicating that the article has been successfully stored for application to the service ticket.

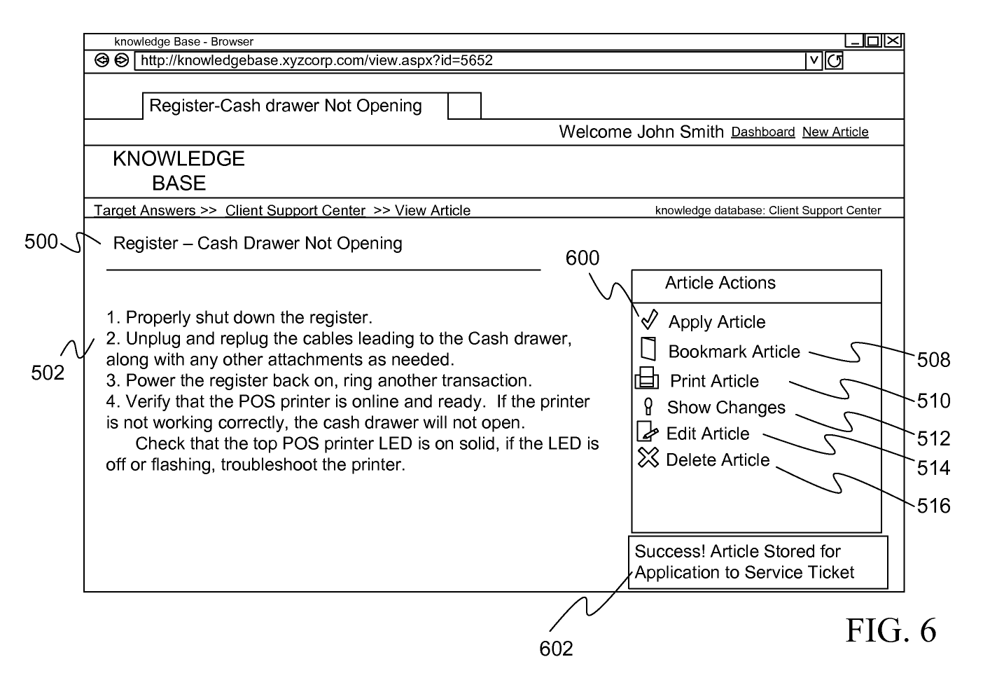

FIG. 6 provides an example of a user interface showing the view webpage of FIG. 5 updated by replacing “apply” icon 520 with “success”/“confirmation” icon 600 and by adding a message 602 in the lower right corner stating that the article has been stored for application to the Service Ticket. In accordance with one embodiment, message 602 is a “toaster” message that moves into the screen in an animated fashion.

If instead of the “apply” icon being selected from the view webpage, the “apply” icon of the search page is selected at step 222, the session identifier, article title, article uniform resource locator (URL) and article identifier are saved in ticketing application table 156 and an indication that the article was successfully stored for later application is displayed at step 224. In particular, the “apply” icon of the search page, such as apply icon 422 of FIG. 4, is changed to a “confirmation” or “success” icon and a message is displayed indicating that the article was successfully stored for application to a service ticket at step 224.

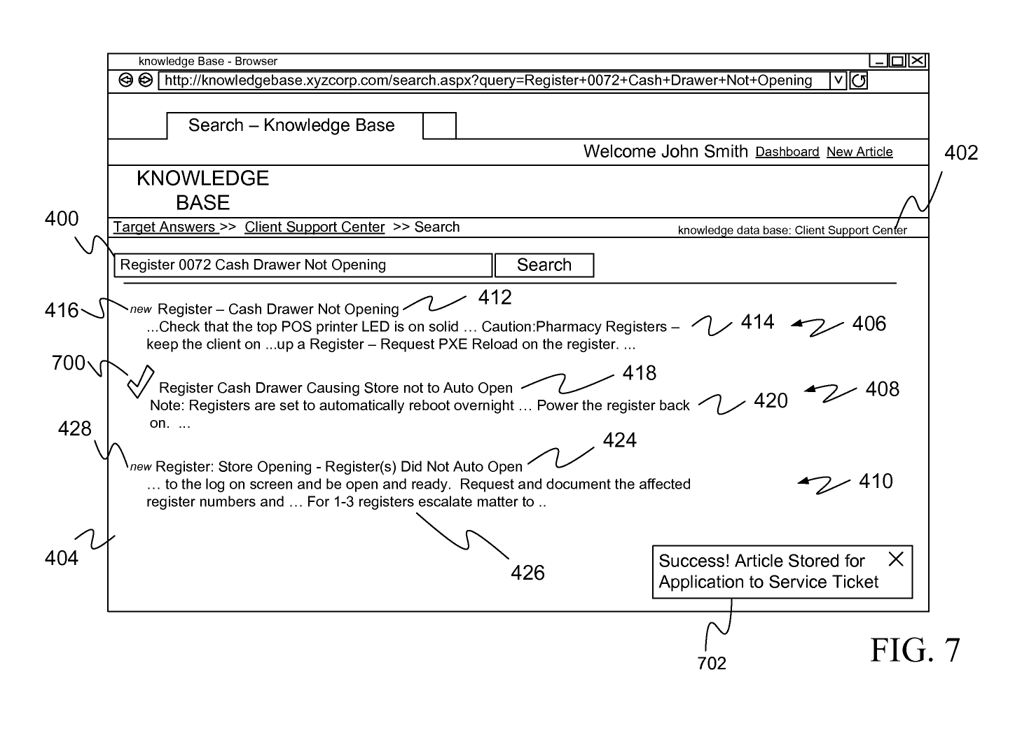

FIG. 7 provides an example of the user interface of FIG. 4 after apply icon 422 is selected at step 222. As shown in FIG. 7, “apply” icon 422 has been changed to a “success” icon in the form of a checkmark 700 in FIG. 7. Further, a text window 702 has appeared in the lower right corner indicating success in storing the article for application to a service ticket.

Note that after step 224, the article information has not been embedded in the service ticket yet. It has only been stored in a database table that can be accessed by web server 124.

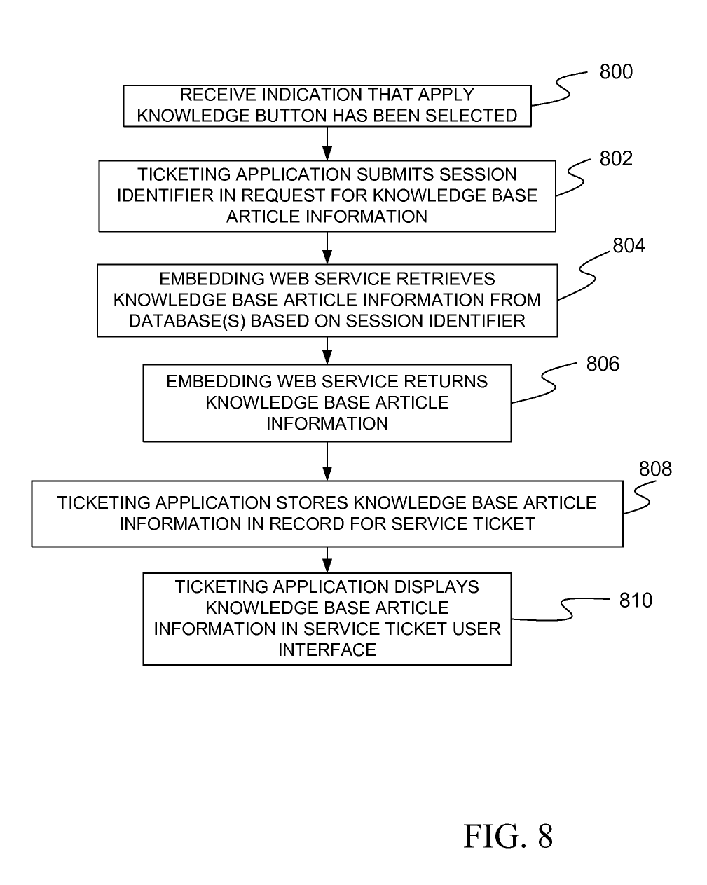

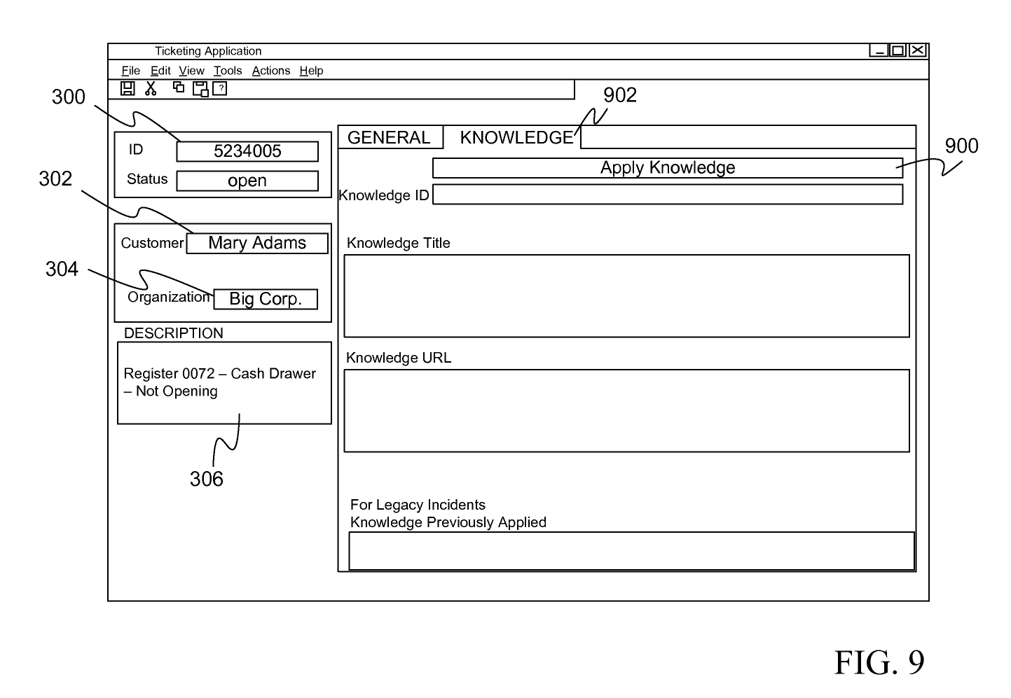

FIG. 8 provides a flow diagram of a method for embedding the article selected in step 222 into the service ticket. At step 800, the ticketing application receives an indication that the user has selected an “apply-knowledge” graphical element/button to apply a knowledge article to a service ticket. FIG. 9 provides an example user interface generated by the ticketing application for applying a knowledge base article to a service ticket. In FIG. 9, an apply-knowledge button 900 is provided under a knowledge tab 902.

After receiving the indication that the apply-knowledge button has been selected, the ticketing application submits the session identifier that was submitted with the search query to an embedding web service application 138 on web server 124. Embedding web server application 138 receives the session identifier in the request for the knowledge base article information from the ticketing application (110, 112, and 114), searches ticketing application table 156 for the session identifier and at step 804, retrieves the article identifier, article URL, and article title from ticketing application table 156 based on the session identifier. At step 806, embedding web service application 138 returns the retrieved information to the ticketing application. The ticketing application then stores this article information with other service ticket information in the service ticketing database associated with the ticketing application. For instance, ticketing application 110 stores the article information and the service ticket information in ticketing database 160 while ticketing application 112 stores the article information and service ticket information in ticketing database 164 and ticketing application 114 stores the article information and service ticket information in ticketing database 168.

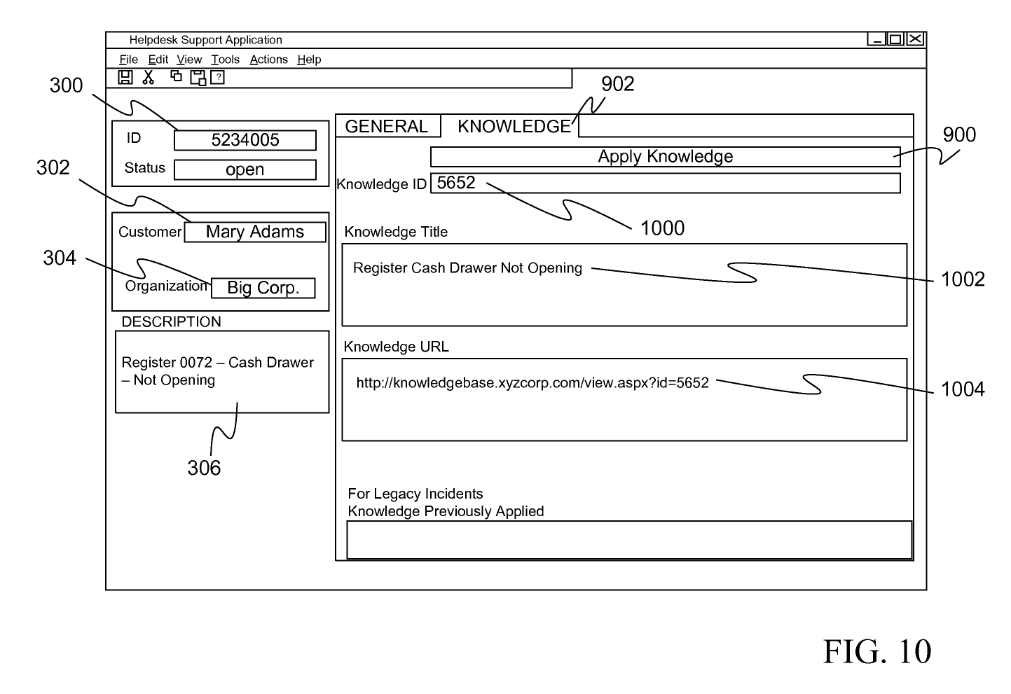

At step 810, the ticketing application displays the article information in the user interface. FIG. 10 provides an example of a user interface displayed by a ticketing application 110, 112 or 114 showing the article identifier in a knowledge ID field 1000, the article title in a knowledge title field 1002, and the article URL shown in knowledge URL field 1004.

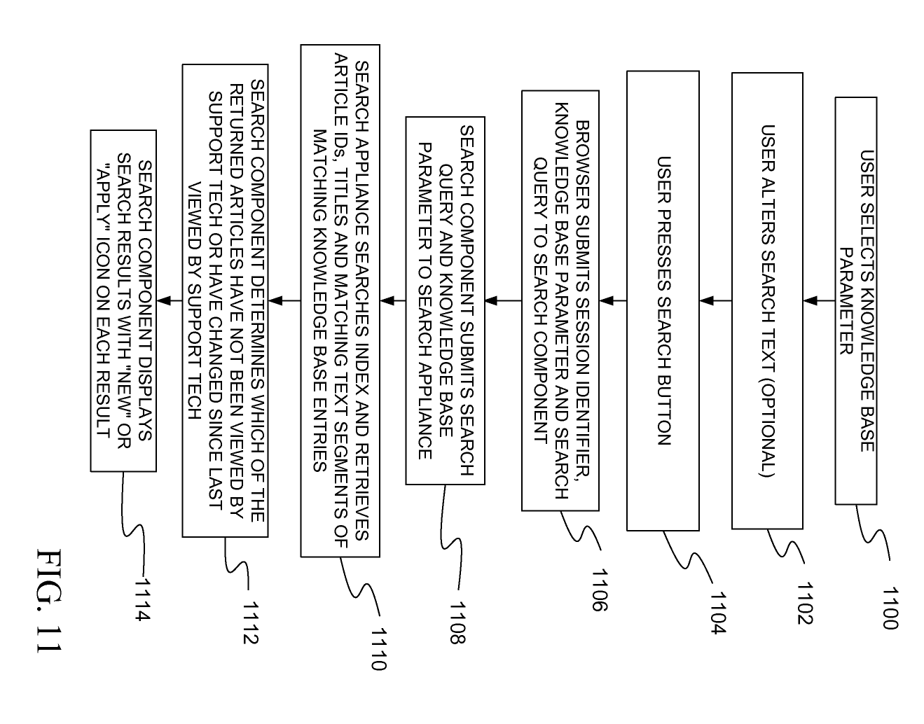

In accordance with some embodiments, users are able to select which records of knowledge base database 140 that the components of knowledge base web application 126 operate against. FIG. 11 provides a flow diagram of a method of switching between knowledge base database records and applying a search to a new set of knowledge base database records.

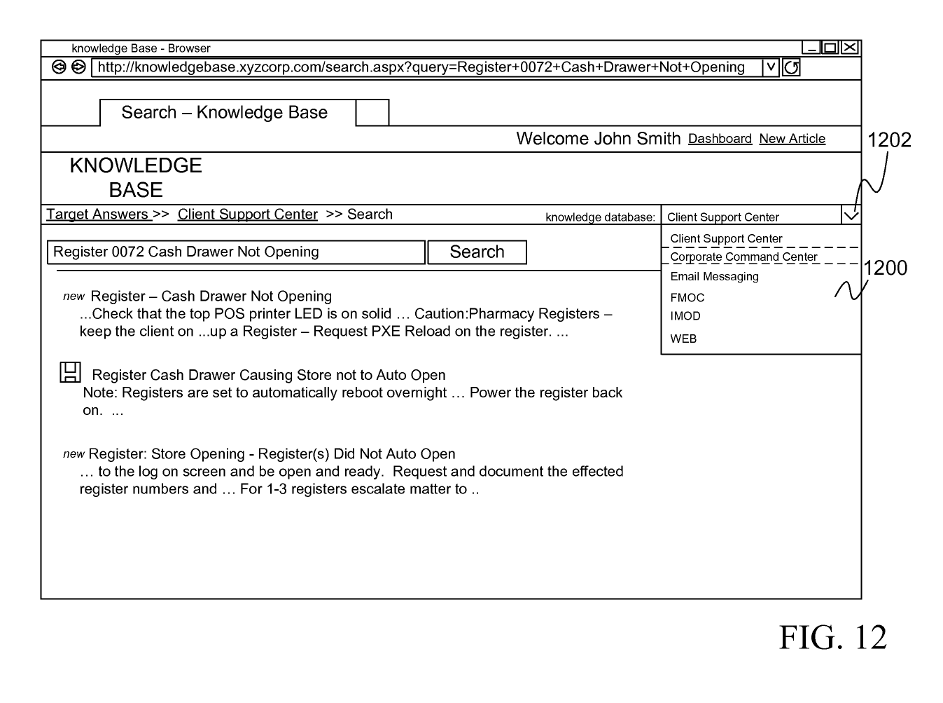

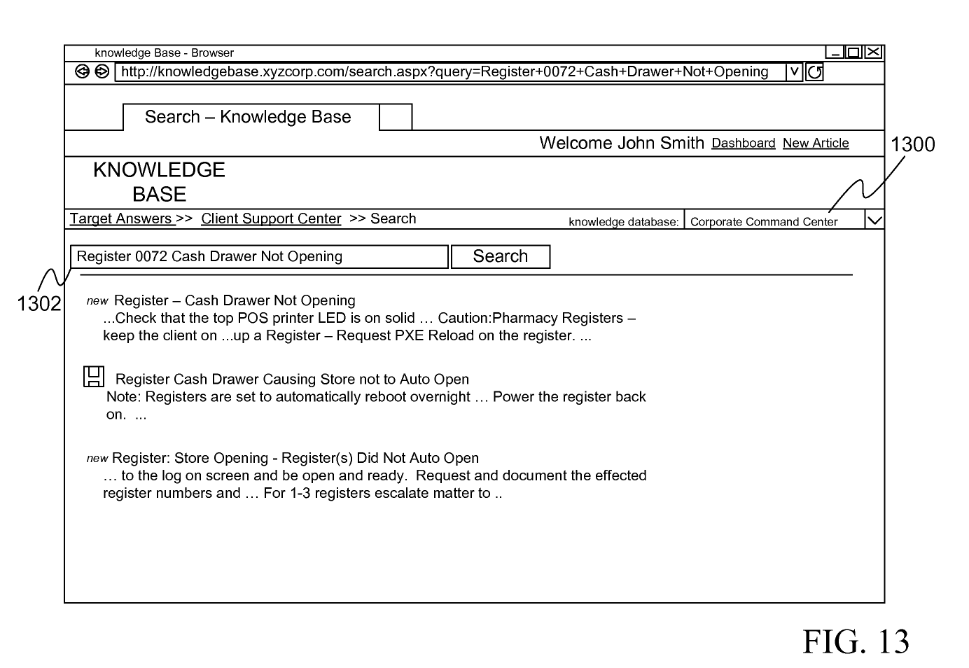

At step 1100, the user selects a knowledge base parameter from a list of available knowledge base parameters. FIG. 12 provides a user interface of a search screen created by search page 132 with a pull down menu 1200 that is activated by pressing icon 1202 and that lists available knowledge base parameters such as “client support center,” “corporate command center,” “email messaging,” “FMOC,” “IMOD,” and “web.” By selecting one of the knowledge base parameters from pull down window 1200, the user selects the knowledge base parameter. This changes the value of the knowledge base parameter in database field 1300 as shown in FIG. 13. At step 1102, the user alters the search text, if desired. This can be done by altering the text in search field 1302. At step 1104, the user presses the search button and at step 1106 browser 120, in response to the pressing of the search button, submits the selected knowledge base parameter and search query to search component 132. Search component 132 passes the selected knowledge base parameter and query to the search appliance 136 at step 1108. At step 1110, search appliance 136 searches search index 154 for the selected knowledge base parameter and query terms and retrieves the article IDs, titles and texts of the matching articles. At step 1112, the search component 132 determines if the user has viewed any of the articles since they were submitted or changed. At step 1114, search component 132 displays the search results with new icons for those articles that have not been displayed to the user since they were written or modified and with apply icons for those articles that have been displayed to the user in their current version. If an apply icon is selected for an article that matches the knowledge base parameter selected in step 1100, the session identifier, article title, article uniform resource locator (URL) and article identifier are saved in ticketing application table 156 and an indication that the article was successfully stored for later application is displayed. In particular, the “apply” icon of the search page is changed to a “confirmation” or “success” icon and a message is displayed indicating that the article was successfully stored for application to a service ticket. Note that because the knowledge base parameter was changed, the article that has been applied to the service ticket is associated with a different ticketing application than the ticketing application that produced the service ticket. Thus, the service ticket is associated with a first ticketing application such as ticketing application 110 and the applied article is associated with a second ticketing application. Thus, embodiments of the present invention allow articles associated with different ticketing applications to be applied to a same service ticket.

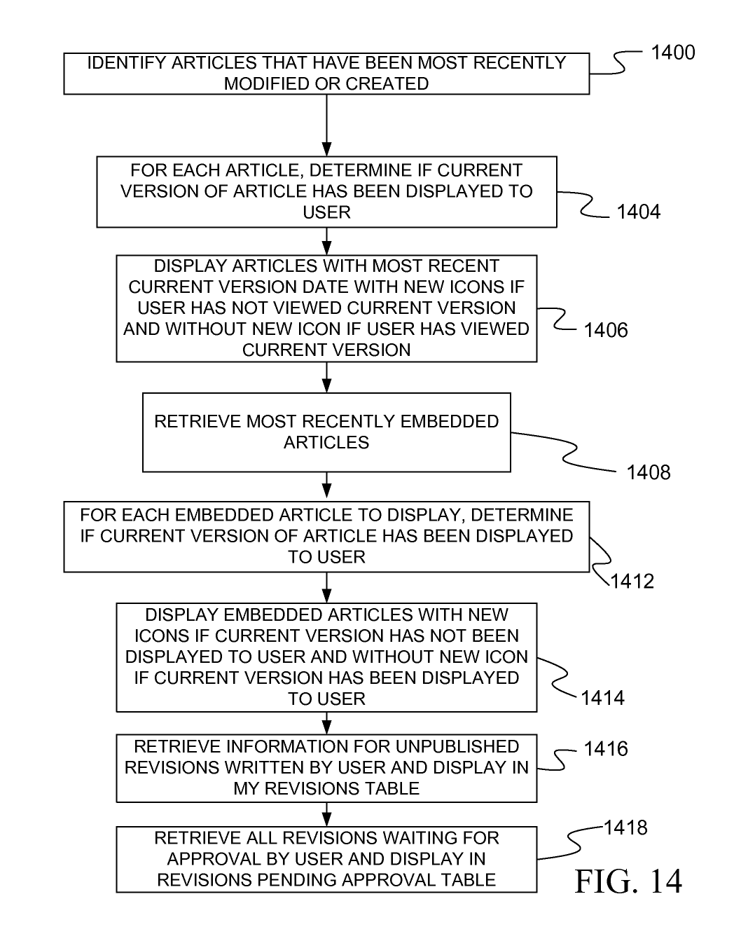

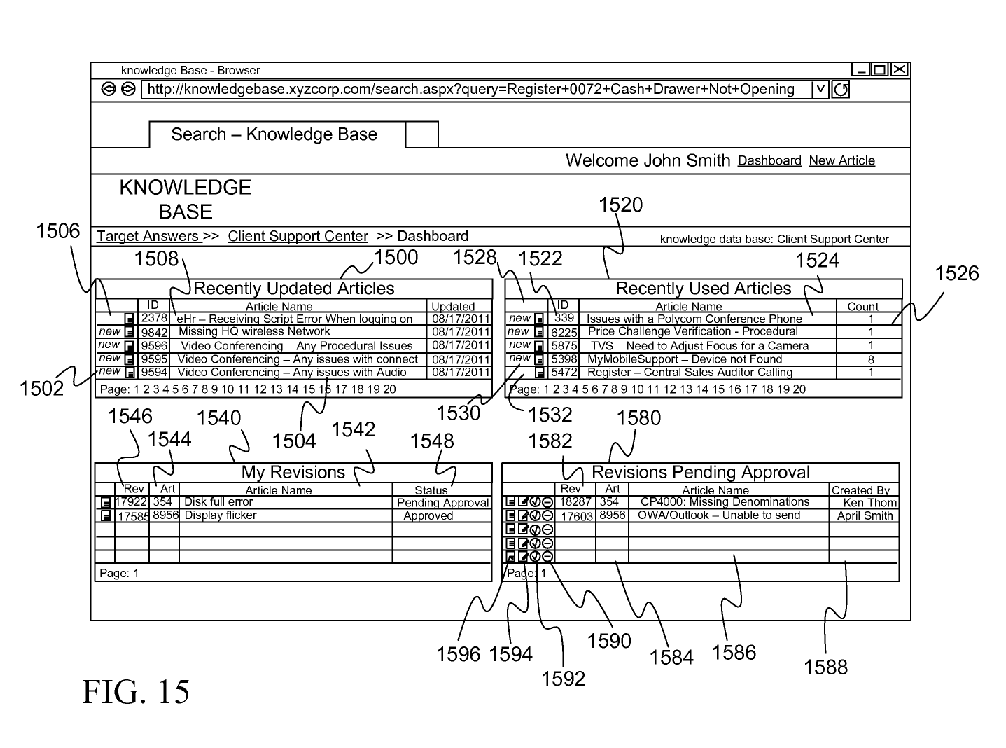

In accordance with some embodiments, knowledge base web application 126 includes a dashboard component 134, which displays a dashboard page such as the page shown in FIG. 15. FIG. 14 provides a method of displaying the user interface of FIG. 15. In step 1400, dashboard component 134 determines which articles have been most recently modified or created by examining the dates that the articles were created or modified in last update table 150. The identified articles are ordered based on the dates that the current version of each article was created. At step 1404, for each article identified in step 1400, dashboard component 134 determines if the current version of the article has been displayed to the user. This determination can be made by examining viewing record table 148 and last update table 150.

At step 1406, dashboard component 134 displays the article ID, article title and update date of the most recently updated articles in a recently updated window 1500 with a “new” icon next to each article that has not been displayed to the user in its current form and a blank space next to each article that has been displayed to the user in its current form. For example, in window 1500, new icon 1502 is provided for article 1504 but no icon is shown in space 1506 for article 1508.

At step 1408, dashboard component 134 retrieves information for the articles that have most recently been embedded in a service ticket. In accordance with one embodiment, to identify the articles that have been embedded in the tickets, dashboard component 134 consults viewing record table 148. The most-recently embedded articles are ordered based on the last date they were applied to a service ticket.

At step 1412, dashboard component 134 determines if any of the most-recently embedded articles have not been displayed to the user in their current form. At step 1414, dashboard component 134 displays the most-recently embedded articles in recently used articles table 1520 providing an article identifier in ID column 1522, a title in an article name column 1524 and a number of service tickets in which the article has been embedded in a count column 1526. In addition, in an icon column 1528, “new” icons are inserted in the rows of articles that have not been displayed to the user in their current form. For example, “new” icon 1530 has been inserted for article ID 5398. Note that no icon is inserted if current version of the article has been displayed to the user as indicated by the empty space 1532 for article ID 5472.

At step 1416, dashboard component 134 retrieves all non-published revisions written by the user and displays them in a “my revisions” table 1540. My revisions table 1540 includes an article name column 1542, article ID column 1544, revision number 1546, and a status column 1548. Revision number 1546 provides an identifier to for the revision, and status column 1548 provides a status for the revision.

At step 1418, dashboard component 134 retrieves all revisions waiting for approval by the user and displays them in a “revisions pending approval” table 1580. Revisions pending approval table 1580 includes a revision number column 1582, an article ID column 1584, an article name column 1586, and a created by column 1588 which contains the name of the user who created the revision. Revisions pending approval table 1580 also includes a rejection icon 1590, an approval icon 1592, an edit icon 1594, and a view icon 1596. By pressing on rejection icon 1590, the user can reject the revision. By pressing approval icon 1592, the user can approve the revision. By pressing edit icon 1594, the user can open the revision for further editing. By pressing view icon 1596, the user can open the revision for viewing.

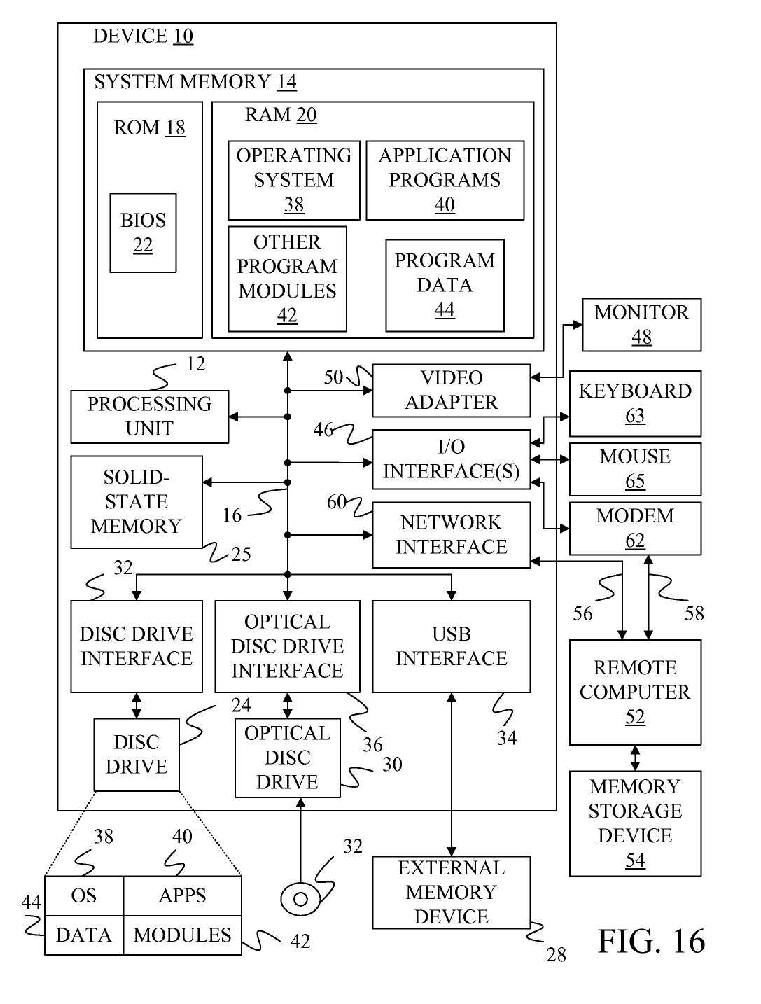

An example of a computing device that can be used as a server and/or client device in the various embodiments described above is shown in the block diagram of FIG. 16. The computing device 10 of FIG. 16 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the personal computer 10, is stored in ROM 18.

Embodiments of the present invention can be applied in the context of computer systems other than personal computer 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computer 10 further includes a hard disc drive 24, non-volatile solid-state memory 25 an external memory device 28, and an optical disc drive 30. External memory device 28 can include an external disc drive or solid state memory that may be attached to computer 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives, solid-state memory and external memory devices and their associated computer-readable media provide nonvolatile storage media for the personal computer 10 on which computer-executable instructions and computer-readable data structures may be stored. Such computer-executable instructions can include instructions for performing any of the steps described in the methods above. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include the ticketing applications, browser, knowledge base web application components (edit, view, search, dashboard), and the embedding web service application discussed above and program data 44 may include data stored in any of the databases or tables discussed above including the service ticket data, knowledge base articles, viewing data, update data, revision data, search indices and ticketing application data.

Input devices including a keyboard 63 and a mouse 65 are connected to system bus 16 through an Input/output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The personal computer 10 may operate in a network environment utilizing connections to one or more remote computers, such as a remote computer 52. The remote computer 52 may be a server, a router, a peer device, or other common network node. Remote computer 52 may include many or all of the features and elements described in relation to personal computer 10, although only a memory storage device 54 has been illustrated in FIG. 16. The network connections depicted in FIG. 36 include a local area network (LAN) 56 and a wide area network (WAN) 58. Such network environments are commonplace in the art.

The personal computer 10 is connected to the LAN 56 through a network interface 60. The personal computer 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the personal computer 10, or portions thereof, may be stored in the remote memory storage device 54. For example, application programs may be stored utilizing memory storage device 54. In addition, data associated with an application program, such as data stored in the databases or tables described above, may illustratively be stored within memory storage device 54. It will be appreciated that the network connections shown in FIG. 16 are exemplary and other means for establishing a communications link between the computers, such as a wireless interface communications link, may be used.

Although elements have been shown or described as separate embodiments above, portions of each embodiment may be combined with all or part of other embodiments described above.

Although the applications and data have been shown stored on various different servers and clients, those skilled in the art will recognize that the distribution of applications and data across these computing devices may be changed without changing the scope of the invention. For example, it is possible to place all the applications and databases on a single computing device. Further, although clients 102, 104, 106 and 108 are shown as not having direct access to database server 146, such access does exist in most embodiments. In particular, it is possible for clients 102, 104, 106 and 108 to retrieve the articles in knowledge base database 140 using the URLs of the articles stored in the service tickets of ticketing databases 160, 164 and 168. The connections between clients 102, 104, 106 and 108 and database server 146 are not shown for the sake of clarity.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method comprising:
determining if a current version of a knowledge base item stored in computer memory has been previously displayed to a user;
if the current version of the knowledge base item has been previously displayed to the user, displaying on a display at least one identifier for the knowledge base item together with an apply-item graphical element such that when the apply-item graphical element is selected, information about the knowledge base item is stored without redisplaying the knowledge base item, wherein the stored information allows a ticketing application to apply the knowledge base item to a service ticket;
if the current version of the knowledge base item has not been displayed to the user, displaying on a display at least one identifier for the knowledge base item together with a new-item graphical element, such that the ticketing application is prevented from applying the knowledge base item to a service ticket on behalf of the user until the current version of the knowledge base item has been displayed to the user.

2. The method of claim 1 wherein displaying at least one identifier for the knowledge base item together with an apply-item graphical element comprises displaying the at least one identifier for the knowledge base item together with the apply-item graphical element in response to a submitted search query.

3. The method of claim 1 further comprising:
if an older version of the knowledge base item has been displayed to the user but the current version of the knowledge base item has not been displayed to the user, displaying the at least one identifier for the knowledge base item together with the new-item graphical element such that the ticketing application is prevented from applying the knowledge base item to a service ticket on behalf of the user until the current version of the knowledge base item has been displayed to the user.

4. The method of claim 1 wherein when the apply-item graphical element is selected, storing information about the knowledge base item comprises storing an item identifier for the knowledge base item and a session identifier provided by the ticketing application in memory.

5. The method of claim 4 wherein after the item identifier for the knowledge base item and the session identifier are stored, displaying a success graphical element in place of the apply-item graphical element.

6. The method of claim 5 wherein after the item identifier for the knowledge base item and the session identifier are stored, displaying a message indicating that the storing was successful.

7. A computer-implemented method comprising:
receiving a first search query and a first knowledge base parameter from a browser client, the first knowledge base parameter being associated with a first ticketing application and the first search query being based on a description of a problem entered in the first ticketing application;
searching a search index to retrieve information about knowledge base articles that match the search query and the first knowledge base parameter;
displaying the information for the knowledge base articles that match the search query and the first knowledge base parameter and displaying the first the knowledge base parameter;
receiving a selection of a second knowledge base parameter associated with a second ticketing application;
displaying the second knowledge base parameter in place of the first knowledge base parameter;
receiving an indication to perform a search based on a second search query;
searching the search index to retrieve information about knowledge base articles that match the second search query and the second knowledge base parameter; and
displaying the information for knowledge base articles that match the second search query and the second knowledge base parameter.

8. The computer-implemented method of claim 7 wherein knowledge base articles that match the first knowledge base parameter comprise knowledge base articles relevant to products supported by the first ticketing application and wherein knowledge base articles that match the second knowledge base parameter comprise knowledge base articles relevant to products supported by the second ticketing application.

9. The computer-implemented method of claim 8 further comprising:
receiving a third search query and the second knowledge base parameter from a second browser client, the third search query being based on a description of a problem entered in the second ticketing application;
searching the search index to retrieve information for knowledge base articles that match the third search query and the second knowledge base parameter; and
displaying the information for the knowledge base articles that match the third search query and the second knowledge base identifier.

10. The computer-implemented method of claim 8 further comprising storing information for a knowledge base article that matches the second knowledge base parameter so that information for the knowledge base article can be stored in a service ticket generated by the first ticketing application.

11. A system comprising:
a web application component configured to provide a web page comprising an identifier for a knowledge base article and an apply-article icon associated with the knowledge base article and configured to receive an indication that the apply-article icon was selected and in response, storing a session identifier and knowledge base article information in a session table;
an embedding web service configured to receive the session identifier in a request for the knowledge base article information from a ticketing application, to retrieve the knowledge base article information from the session table using the session identifier, and to forward the knowledge base article information to the ticketing application.

12. The system of claim 11 wherein the web application receives the session identifier from the ticketing application.

13. The system of claim 12 wherein the web application provides the web page in response to search terms received from the ticketing application.

14. The system of claim 12 wherein the knowledge base article information comprises a uniform resource locator of the knowledge base article.

15. The system of claim 11 wherein the web application component is further configured to provide a second web page in response to receiving the indication that the apply-article icon was selected, the second web page comprising a confirmation icon that has replaced the apply-article icon, the confirmation icon indicating that the knowledge base article has been applied to the service ticket.

16. The system of claim 15 wherein the second web page further comprises a text box indicating that the knowledge base article has been applied to the service ticket.

17. A method of generating a graphical user interface on a display, the method comprising:
retrieving information about articles in a knowledge base stored in memory, the information including a date that a current version of the article was created;
displaying a recently updated articles table in the graphical user interface that shows information about at least two of the articles in the knowledge base ordered based on the dates that the current version of each article was created;
identifying articles in the knowledge base that have been applied to a service ticket as recently used articles and for each recently used article, identifying the last date that the recently used article was applied to a service ticket;
displaying a recently used articles table in the graphical user interface that shows information about at least two recently used articles ordered based on the last dates the articles were applied to a service ticket.

18. The method of claim 17 wherein displaying the recently updated articles table and displaying the recently used articles table comprises displaying an indication of whether a current user has viewed a current version of each article shown in each table.

19. The method of claim 17 further comprising:
identifying articles in the knowledge base that a current user has revised; and
displaying a current user's revision table that shows information about at least one article that the current user has revised.

20. The method of claim 17 further comprising:
identifying articles in the knowledge base that have been revised and that are waiting for approval by a current user; and
displaying a revisions pending approval table that shows information about at least one article that is waiting for approval by the current user.
